(19) United States
(12) Patent Application Publication
(10) Pub. No.: US 2013/0155241 A1
(43) Pub. Date: Jun. 20, 2013

(54) SURROUNDING AREA MONITORING DEVICE FOR WORK VEHICLE

(71) Applicants: Tomikazu Tanuki, Fujisawa-shi (JP); Shigeru Harada, Chigasaki-shi (JP); Shinji Mitsuta, Hiratsuka-shi (JP); Eishin Masutani, Hiratsuka-shi (JP); Yukihiro Nakanishi, Hiratsuka-shi (JP); Takeshi Kurihara, Hiratsuka-shi (JP); Dai Tsubone, Hiratsuka-shi (JP); Masaomi Machida, Hiratsuka-shi (JP)

(72) Inventors: Tomikazu Tanuki, Fujisawa-shi (JP); Shigeru Harada, Chigasaki-shi (JP); Shinji Mitsuta, Hiratsuka-shi (JP); Eishin Masutani, Hiratsuka-shi (JP); Yukihiro Nakanishi, Hiratsuka-shi (JP); Takeshi Kurihara, Hiratsuka-shi (JP); Dai Tsubone, Hiratsuka-shi (JP); Masaomi Machida, Hiratsuka-shi (JP)

(73) Assignee: KOMATSU LTD., Tokyo (JP)

(21) Appl. No.: 13/818,908

(22) PCT Filed: May 23, 2012
(86) PCT No.: PCT/JP2012/063137

§ 371 Date: Feb. 25, 2013

(30) Foreign Application Priority Data
Jun. 7, 2011 (JP) JP2011-127306

(51) Int. Cl. H04N 7/18

(52) U.S. Cl. CPC H04N 7/181
USPC 348/148

(57) ABSTRACT

A surrounding area monitoring device for a work vehicle includes a first imaging unit, a bird's-eye view image creating unit, and a display unit. The first imaging unit is mounted on the work vehicle and configured and arranged to capture an image of a first region in a surrounding area of the work vehicle to obtain a first image data. The birds-eye view image creating unit is configured to create a bird's-eye view image of the surrounding area of the work vehicle by projecting the first image data on a predetermined virtual projection plane. The display unit is configured and arranged to display the bird's-eye view image. The virtual projection plane includes a shape that increases in height from a ground surface as a distance from the work vehicle decreases.

### CROSS-REFERENCE TO RELATED APPLICATIONS

This application claims priority to Japanese Patent Application No. 2011-127306 filed on Jun. 7, 2011, the disclosure of which is hereby incorporated herein by reference in its entirety.

### TECHNICAL FIELD

The present invention relates to a surrounding area monitoring device for a work vehicle.

### BACKGROUND ART

Conventionally, trucks are widely used as large scale work vehicles for carrying crushed stone at mines and the like. Since these types of dump trucks are markedly wider and longer from front to back than typical vehicles, a driver finds it difficult to discern the conditions in the area surrounding the work vehicle using the side mirrors and the like.

On the one hand, a surrounding area monitoring device has been proposed for allowing a driver to easily understand the conditions surrounding the vehicle. The surrounding area monitoring device includes an imaging unit such as a camera mounted on the vehicle. The surrounding area monitoring device creates a bird's-eye view image showing the area surrounding the work vehicle by synthesizing images taken by the imaging unit. For example, in an automobile surrounding area monitoring device disclosed in Japanese Patent Laid-open No. H3-099952, a bird's-eye view image is created by projecting an image taken by the imaging unit on a virtual projection plane.

### SUMMARY

A bird's-eye view image is created by projecting an image on a virtual projection plane. As a result, there is a problem in that an object located near the vehicle is displayed in a small manner in the bird's-eye view image. For example, as illustrated in FIG. 17, an object OB1 and an object OB2 are located in an area surrounding a vehicle 100. The object OB2 is located nearer the vehicle 100 than the object OB1. The images taken by an imaging unit 101 of the objects OB1 and OB2 are created as a bird's-eye view image as seen from a virtual viewpoint 103 by being projected on a virtual projection plane 300. The virtual projection plane 300 is located on the ground surface. In this case, an angle θ2 of the viewpoint from the imaging unit 101 to the object OB2 has a more acute angle than an angle θ1 of the viewpoint to the object OB1. As a result, although the object OB1 is displayed as a size corresponding to a size L10 in the bird's-eye view image, the object OB2 is displayed as a size corresponding to L20 which is smaller than L10. In this way, the driver has difficulty in discerning an object nearer the vehicle in the bird's-eye view image when that object is displayed in a small manner in the bird's-eye view image. In particular, unlike a typical automobile, many regions that are blind spots in the area surrounding the work vehicle from the perspective of the driver exist around a work vehicle with a very large body size. As a result, it is important to be able to easily recognize objects located near a work vehicle.

An object of the present invention is to provide a surrounding area monitoring device for a work vehicle, the device capable of easily recognizing an object located near a work vehicle in a bird's-eye view image.

A work vehicle surrounding area monitoring device according to a first aspect of the present invention includes a first imaging unit, a bird's-eye view image creating unit, and a display unit. The first imaging unit is mounted on the work vehicle. The first imaging unit obtains first image data as an image of a first region in a surrounding area of the work vehicle. The bird's-eye view image creating unit creates a bird's-eye view image of the surrounding area of the work vehicle by projecting the first image data on a predetermined virtual projection plane. The display unit displays the bird's-eye view image. The virtual projection plane includes a shape that increases in height from the ground surface as a distance from the work vehicle decreases.

A work vehicle surrounding area monitoring device according to a second aspect of the present invention is related to the work vehicle surrounding area monitoring device according to the first aspect, wherein a virtual projection plane includes a varying portion and a flat portion. The varying portion increases in height from the ground surface as the distance from the work vehicle decreases. The flat portion is continuously joined to the varying portion in a location further away from the work vehicle than the varying portion. The height of the flat portion from the ground is uniform. The varying portion is located between the work vehicle and the flat portion.

A work vehicle surrounding area monitoring device according to a third aspect of the present invention is related to the work vehicle surrounding area monitoring device according to the second aspect, wherein a connecting portion of the varying portion and the flat portion is located on the ground surface.

A work vehicle surrounding area monitoring device according to a fourth aspect of the present invention is related to the work vehicle surrounding area monitoring device according to the first aspect, wherein the virtual projection plane includes a first varying portion, a flat portion, and a second varying portion. The first varying portion increases in height from the ground surface as the distance from the work vehicle decreases. The flat portion is continuously joined to the first varying portion in a location further away from the work vehicle than the first varying portion. The height of the flat portion from the ground is uniform. The second varying portion is continuously joined to the flat portion in a location further away from the work vehicle than the flat portion. The second varying portion increases in height from the ground surface as the distance from the work vehicle increases.

A work vehicle surrounding area monitoring device according to a fifth aspect of the present invention is related to the work vehicle surrounding area monitoring device according to the fourth aspect, wherein a connecting portion of the second varying portion and the flat portion is located on the ground surface.

A work vehicle surrounding area monitoring device according to a sixth aspect of the present invention is related to the work vehicle surrounding area monitoring device according to the first aspect, and further includes a second imaging unit. The second imaging unit is mounted on the work vehicle. The second imaging unit images a second region to obtain second image data. The second region is a region of the area surrounding the work vehicle that partially overlaps the first region. The bird's-eye view image creating unit displays by overlapping, in the bird's-eye view image, an image of the first image data in an overlapping region in which the first region and the second region overlap, with an image of the second image data in the overlapping region.

A work vehicle according to a seventh aspect of the present invention includes the surrounding area monitoring device of any one of the first to sixth aspects.

The virtual projection plane includes a shape that increases in height from the ground surface in correspondence as the distance from the work vehicle decreases. As a result, an object located near the vehicle is displayed in an enlarged manner in the bird's-eye view image. Accordingly, an object located near the work vehicle can be easily recognized in the bird's-eye view image.

In the work vehicle surrounding area monitoring device according to the second aspect of the present invention, an object is displayed smoothly in the bird's-eye view image due to the varying portion and the flat portion being continuously joined. As a result, a bird's-eye view image can be made that has little sense of discomfort for the operator. Moreover, since the flat portion is in a location further away from the work vehicle than the varying portion, deformation of the object is suppressed in the bird's-eye view image in a location removed from the work vehicle.

In a work vehicle surrounding area monitoring device according to the third aspect of the present invention, the connecting portion of the varying portion and the flat portion is located on the ground surface. That is, the flat portion is in a flat surface on the ground surface. As a result, a natural bird's-eye view image can be created that seems to be imaging the ground surface from the operator's point of view.

In the work vehicle surrounding area monitoring device according to the fourth aspect of the present invention, an object is displayed in an enlarged manner near the work vehicle in the bird's-eye view image due to the first varying portion of the virtual projection plane. Since the flat portion is in a location further away from the work vehicle than the varying portion, the object imaged in the flat portion is displayed in an enlarged manner in the bird's-eye view image. Moreover, although the object is displayed in the flat portion in a correspondingly enlarged manner further away from the work vehicle, the second varying portion is provided in a location further away from the work vehicle than the flat portion. Since the second varying portion increases in height from the ground surface as the distance from the work vehicle increases, the object is displayed in a small manner correspondingly further away from the work vehicle. As a result, a feeling of distance between the object and the work vehicle can be easily understood due to the bird's-eye view image. Further, the first varying portion and the flat portion are continuously joined. Moreover, the flat portion and the second varying portion are continuously joined. As a result, an object can be smoothly displayed in the bird's-eye view image. As a result, a bird's-eye view image can be created that does not easily cause a sense of discomfort for the operator.

In the work vehicle surrounding area monitoring device according to the fifth aspect of the present invention, the connecting portion of the second varying portion and the flat portion is located on the ground surface. That is, the flat portion is on a flat surface on the ground surface. As a result, a natural bird's-eye view image can be created that seems to have imaged the ground surface from the operator's point of view. Moreover, the height from the ground surface in the first varying portion becomes higher from the ground surface as the distance from the work vehicle decreases. As a result, an object near the work vehicle is displayed in a larger manner in the bird's-eye view image than when the virtual projection plane is a flat surface over the entire ground surface. Moreover, the height of the second varying portion from the ground surface increases in height from the ground surface as the distance from the work vehicle increases. As a result, a feeling of distance between the object and the work vehicle can be more easily understood due to the bird's-eye view image than when the virtual projection plane is a flat surface over the entire ground surface.

In the work vehicle surrounding area monitoring device according to the sixth aspect of the present invention, the bird's-eye view image creating unit overlaps and displays an image of the first image data and an image of the second image data in the overlapping region. As a result, a disappearance of the object in the overlapping region in the bird's-eye view image can be suppressed. Moreover, an object located near the work vehicle in the overlapping region is displayed in an enlarged manner in the bird's-eye view image since the virtual projection plane includes a shape that becomes higher from the ground surface as the distance from the work vehicle decreases. As a result, an object located near the work vehicle can be easily recognized in the overlapping region of the imaging unit in the bird's-eye view image.

In the work vehicle according to the seventh aspect of the present invention, the virtual projection plane includes a shape that increases in height from the ground surface as the distance from the work vehicle decreases. As a result, an object located near the vehicle is displayed in an enlarged manner in the bird's-eye view image. Accordingly, an object located near the work vehicle can be easily recognized in the bird's-eye view image.

### BRIEF DESCRIPTION OF DRAWINGS

FIG. 1 is a perspective view of an overall configuration of a work vehicle according to an embodiment of the present invention.

FIG. 2 is a block diagram describing a configuration of a surrounding area monitoring device according to an embodiment of the present invention.

FIG. 3 is a perspective view of a work vehicle illustrating mounting locations of a plurality of imaging units of the surrounding area monitoring device.

FIG. 4 is a top view illustrating imaging ranges and the mounting locations of the plurality of imaging units of the surrounding area monitoring device.

FIG. 5 illustrates an image conversion method using a virtual projection plane.

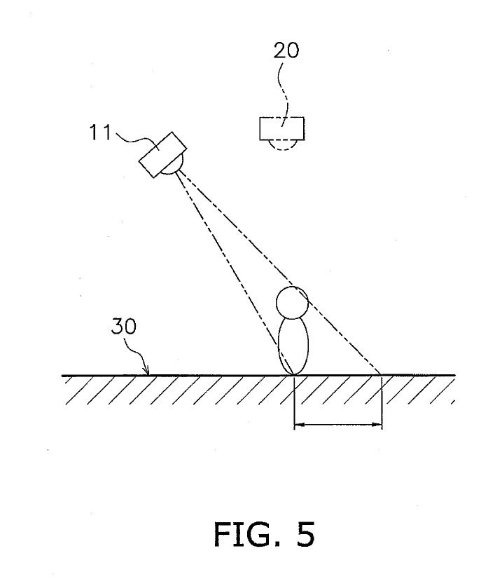

FIG. 6 includes schematic views illustrating an example of a first virtual projection plane.

FIG. 7 includes schematic views illustrating an example of a second virtual projection plane.

FIG. 8 is a top view illustrating first to vicinal ranges included in the virtual projection plane.

FIG. 9 is a flow chart of a process executed by a controller of the surrounding area monitoring device.

FIG. 10 is a schematic view illustrating an example of a bird's-eye view image in a stopped state.

FIG. 11 is a schematic view illustrating an example of a bird's-eye view image in a traveling state.

FIG. 12 is a schematic view for explaining an effect of the surrounding area monitoring device according to the present embodiment.

FIG. 13 is a schematic view for explaining a cause of the disappearance of an object in a conventional surrounding area monitoring device.

FIG. 14 is a schematic view for explaining an effect of the surrounding area monitoring device according to the present embodiment.

FIG. 15 is a schematic view for explaining an effect of the surrounding area monitoring device according to the present embodiment.

FIG. 16 includes schematic views illustrating an example of a first virtual projection plane according to another embodiment.

FIG. 17 is a schematic view for explaining a problem of the conventional surrounding area monitoring device.

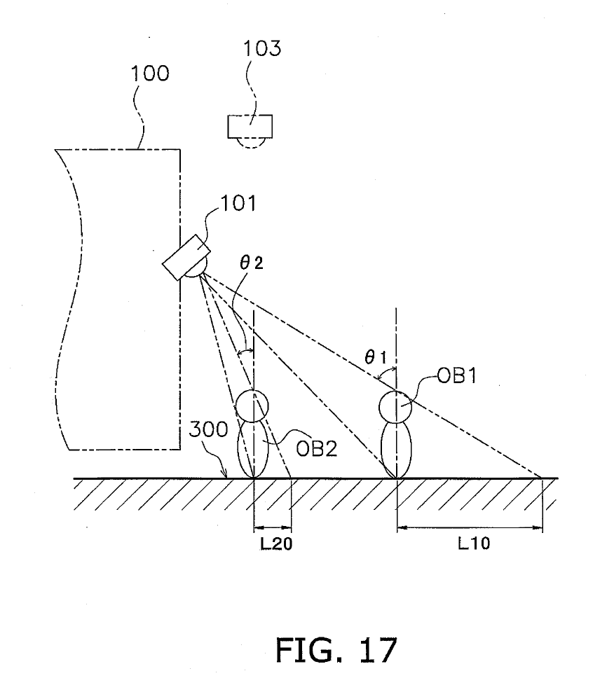

### DESCRIPTION OF EMBODIMENTS

Hereinbelow, embodiments of the present invention will be described with reference to the accompanying drawings. In the following description, “front,” “back,” “left,” and “right” are terms used on the basis of a driver sitting in the driver's seat. Further, “vehicle width direction” and “left and right direction” have the same meaning.

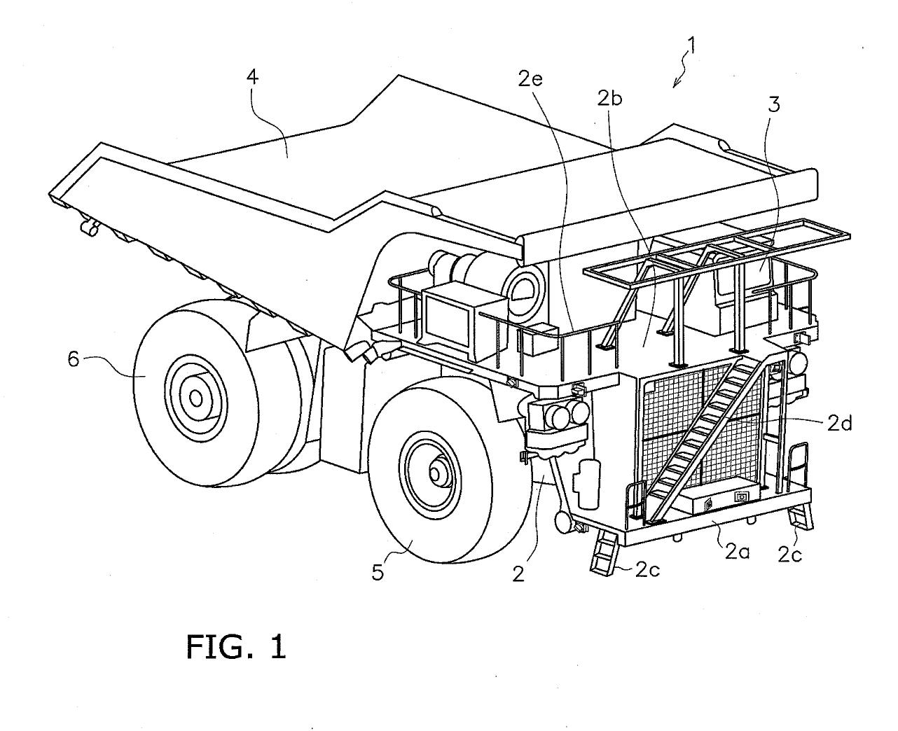

FIG. 1 is a perspective view of an overall configuration of a work vehicle 1 according to an embodiment of the present invention. The work vehicle 1 is a self-propelled extra-large dump truck used in mining operations and the like.

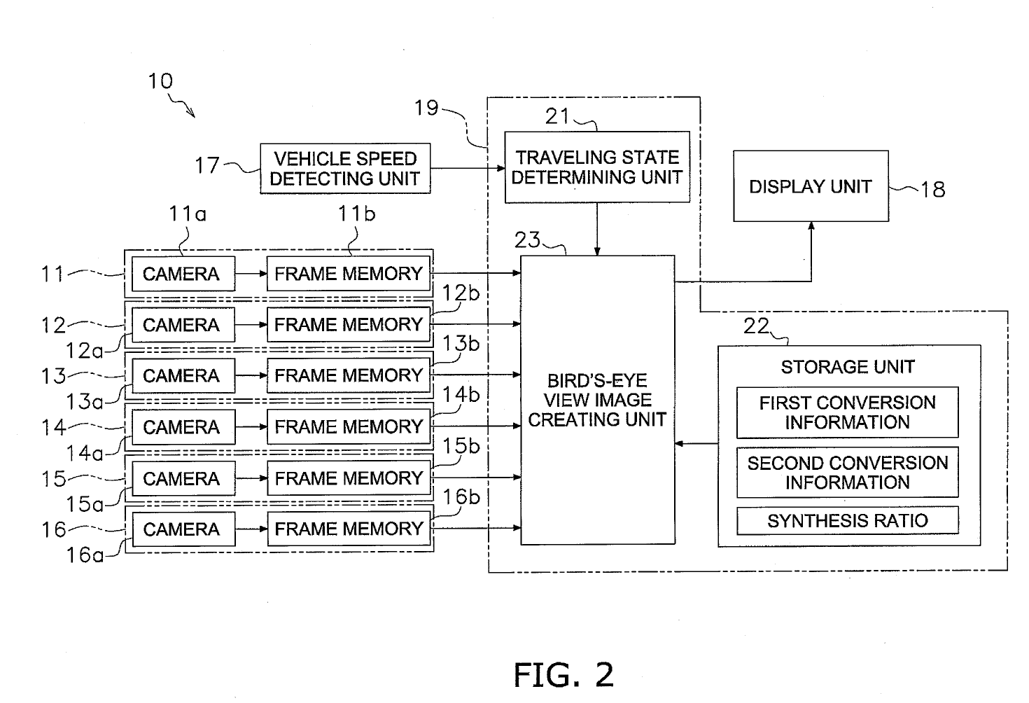

The work vehicle 1 mainly includes a vehicle frame 2, a cab 3, a vessel 4, front wheels 5, and rear wheels 6. The work vehicle 1 includes a surrounding area monitoring device 10 (see FIG. 2) that monitors a surrounding area of the work vehicle 1 and displays the result. Details of the surrounding area monitoring device 10 are described below.

The vehicle frame 2 supports power mechanisms such as a diesel engine and transmission (not shown), and other peripheral equipment. Left and right front wheels 5 (only the right front wheel is illustrated in FIG. 1) are supported at the front portion of the vehicle frame 2. Left and right rear wheels 6 (only the right rear wheel is illustrated in FIG. 1) are supported at the back portion of the vehicle frame 2. The vehicle frame 2 has a lower deck 2a and an upper deck 2b. The lower deck 2a is attached to a bottom portion of the front face of the vehicle frame 2. The upper deck 2b is disposed above the lower deck 2a. A movable ladder 2c, for example, is disposed between the lower deck 2a and the ground surface. A diagonal ladder 2d is disposed between the lower deck 2a and the upper deck 2b. A palisaded handrail 2e is disposed on the upper deck 2b.

The cab 3 is disposed on the upper deck 2b. The cab 3 is located toward one side in the vehicle width direction from the center of the vehicle width direction on the upper deck 2b. Specifically, the cab 3 is located on the left side of the center of the vehicle width direction on the upper deck 2b. Operating members (not shown) such as a driver seat, a steering wheel, a shift lever, an accelerator pedal, and a braking pedal and the like are provided inside the cab 3.

The vessel 4 is a container for loading heavy objects such as crushed rock. The rear portion of the bottom of the vessel 4 is connected to the rear portion of the vehicle frame 2 via a pivot pin (not shown) to allow for pivoting. The vessel 4 is able to assume a loading orientation and an erect orientation due to an actuator such as a hydraulic cylinder (not shown). The loading orientation is one in which the front of the vessel 4 is located above the cab 3 as illustrated in FIG. 1. The erect orientation is one for discharging loaded objects in a state in which the vessel 4 is inclined in a direction rearward and downward. By pivoting the front portion of the vessel upward, the vessel 4 changes from the loading orientation to the erect orientation.

FIG. 2 is a block diagram illustrating a configuration of a surrounding area monitoring device 10 provided in the work vehicle 1. The surrounding area monitoring device 10 has a plurality of imaging units 11 to 16, a vehicle speed detecting unit 17, a display unit 18, and a controller 19.

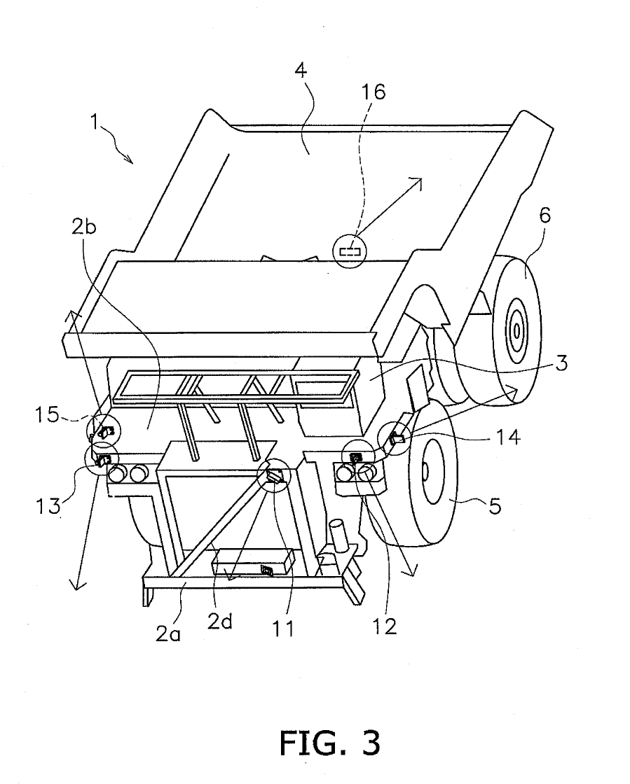

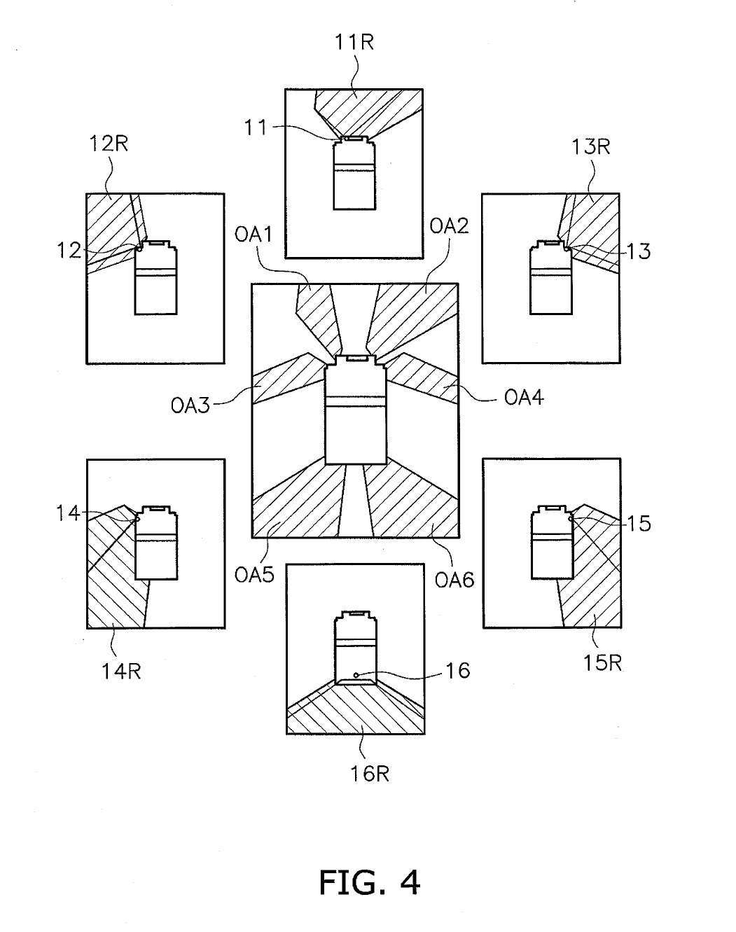

The imaging units 11 to 16 are mounted on the work vehicle 1. The imaging units 11 to 16 image the surrounding area of the work vehicle 1 to obtain image data. The imaging units 11 to 16 respectively have cameras 11a to 16a and frame memories 11b to 16b. The frame memories 11b to 16b temporarily save image data imaged by the cameras 11a to 16a. The plurality of imaging units 11 to 16 have first to sixth imaging units 11 to 16. FIG. 3 is a work vehicle 1 perspective view illustrating mounting locations of the first to sixth imaging units 11 to 16. FIG. 4 is a work vehicle 1 top view illustrating mounting locations and imaging ranges of the first to sixth imaging units 11 to 16.

As illustrated in FIG. 3, the first imaging unit 11 is attached to the front surface of the work vehicle 1. Specifically, the first imaging unit 11 is disposed on a top portion of the diagonal ladder 2d. As illustrated in FIG. 4, the first imaging unit 11 images a first region 11R of the surrounding area of the work vehicle 1 to obtain the first image data. The first region 11R is located forward of the work vehicle 1.

As illustrated in FIG. 3, the second imaging unit 12 is attached to one side on the front surface of the work vehicle 1. Specifically, the second imaging unit 12 is disposed on a left side portion on the front surface of the upper deck 2b. As illustrated in FIG. 4, the second imaging unit 12 images a second region 12R to obtain the second image data. The second region 12R is located diagonally forward left of the work vehicle 1. As illustrated in FIG. 3, the third imaging unit 13 is attached to the other side on the front surface of the work vehicle 1. Specifically, the third imaging unit 13 is mounted in a location having left-right symmetry with the second imaging unit 12. Specifically, the third imaging unit 13 is disposed on a right side portion on the front surface of the upper deck 2b. As illustrated in FIG. 4, the third imaging unit 13 images a third region 13R of the surrounding area of the work vehicle 1 to obtain the third image data. The third region 13R is located diagonally forward right of the work vehicle 1.

As illustrated in FIG. 3, the fourth imaging unit 14 is attached one side surface of the work vehicle 1. Specifically, the fourth imaging unit 14 is disposed on a front portion of a left side surface of the upper deck 2b. As illustrated in FIG. 4, the fourth imaging unit 14 images a fourth region 14R of the surrounding area of the work vehicle 1 to obtain fourth image data. The fourth region 14R is located diagonally rearward left of the work vehicle 1. As illustrated in FIG. 3, the fifth imaging unit 15 is attached to the other side surface of the work vehicle 1. Specifically, the fifth imaging unit 15 is mounted in a location having left-right symmetry with the fourth imaging unit 14. Specifically, the fifth imaging unit 15 is disposed on a front portion on the right side surface of the upper deck 2b. As illustrated in FIG. 4, the fifth imaging unit 15 images a fifth region 15R of the surrounding area of the work vehicle 1 to obtain fifth image data. The fifth region 15R is located diagonally rearward right of the work vehicle 1.

As illustrated in FIG. 3, the sixth imaging unit 16 is attached to the rear portion of the work vehicle 1. Specifically, the sixth imaging unit 16 is disposed above the axle (not shown) connecting the two rear wheels 6, and near a pivoting shaft of the vessel 4. As illustrated in FIG. 4, the sixth imaging unit 16 images a sixth region 16R of the surrounding area of the work vehicle 1 to obtain the sixth image data. The sixth region 16R is located rearward of the work vehicle 1.

As illustrated in the center figure in FIG. 4, the abovementioned six imaging units 11 to 16 are able to obtain images of substantially the entire surrounding area of the work vehicle 1. Two adjacent regions among the first to sixth region 16R partially overlap each other as illustrated in the center figure in FIG. 4. Specifically, the first region 11R partially overlaps the second region 12R in a first overlapping region OA1. The first region 11R partially overlaps the third region 13R in a second overlapping region OA2. The second region 12R partially overlaps the fourth region 14R in a third overlapping region OA3. The third region 13R partially overlaps the fifth region 15R in a fourth overlapping region OA4. The fourth region 14R partially overlaps the sixth region 16R in a fifth overlapping region OA5. Moreover, the fifth region 15R partially overlaps the sixth region 16R in a sixth overlapping region OA6. The first to sixth imaging units 11 to 16 transmit the image data representing the imaged images to the controller 19.

The vehicle speed detecting unit 17 detects the vehicle speed of the work vehicle 1. The vehicle speed detecting unit 17 detects the vehicle speed of the work vehicle 1 on the basis of, for example, the rotation speed of an output shaft of the transmission. The vehicle speed detecting unit 17 transmits the vehicle speed data that indicates the detected vehicle speed to the controller 19.

The display unit 18 is a monitor disposed inside the cab 3. The display unit 18 is disposed in front of the driver seat inside the cab 3. The display unit 18 displays images in response to controlling by the controller 19.

The controller 19 creates a bird's-eye view image that shows the surrounding area of the work vehicle 1 based on the image data from the imaging units 11 to 16. The controller 19 outputs output signals that represent the created bird's-eye view image to the display unit 18. The display unit 18 displays the bird's-eye view image based on the output signals from the controller 19. As illustrated in FIG. 2, the controller 19 has a traveling state determining unit 21, a storage unit 22, and a bird's-eye view image creating unit 23.

The traveling state determining unit 21 determines a traveling state of the work vehicle 1 on the basis of the vehicle speed data from the vehicle speed detecting unit 17. The traveling state determining unit 21 determines that the work vehicle 1 is in the traveling state when the vehicle speed is equal to or greater than a predetermined threshold. The traveling state determining unit 21 determines that the work vehicle 1 is in a stopped state when the vehicle speed is less than the predetermined threshold. Therefore, in addition to the vehicle speed being zero, a slow traveling state when the vehicle speed is slow is included in the above stopped state.

The storage unit 22 stores various types of information required for the controller 19 to create the bird's-eye view image. Specifically, the storage unit 22 stores first conversion information, second conversion information, and a synthesis ratio to be described below.

The bird's-eye view image creating unit 23 receives the image data from each of the imaging units 11 to 16. The bird's-eye view image creating unit 23 creates the bird's-eye view image of the surrounding area of the work vehicle 1 on the basis of a plurality of images represented by the image data. Specifically, the bird's-eye view image creating unit 23 uses conversion information saved in the storage unit 22 to a coordinate conversion of the image data. The conversion information is information that indicates an association between location coordinates of pixels of an input image and location coordinates of pixels of an output image. An input image is an image imaged by the imaging units 11 to 16. Further, the output image is a bird's-eye view image displayed on the display unit 18. The bird's-eye view image creating unit 23 uses the conversion information to convert images imaged by the imaging units 11 to 16 to images seen from a predetermined virtual viewpoint located above the work vehicle 1. Specifically, the images imaged by the imaging units 11 to 16 are converted to images seen from a virtual viewpoint 20 located above the work vehicle 1 due to the images imaged by the imaging units 11 to 16 being projected on a predetermined virtual projection plane 30. The conversion information represents the virtual projection plane 30. The bird's-eye view image creating unit 23 creates the bird's-eye view image of the surrounding area of the work vehicle 1 by projecting and synthesizing the image data from the plurality of imaging units 11 to 16 on a predetermined virtual projection plane. Specifically, the bird's-eye view image of the surrounding area of the work vehicle 1 is created by projecting and synthesizing the first to sixth image data on the predetermined virtual projection plane.

As described above, regions in surrounding areas of the work vehicle 1 imaged by the imaging units 11 to 16 overlap in the first to sixth overlapping regions OA1 to OA6. The bird's-eye view image creating unit 23 overlaps images of the image data from two of the imaging units 11 to 16 adjacent to each other and displays the overlapping images in the overlapping regions OA1 to OA6. Specifically, the bird's-eye view image creating unit 23 overlaps the image of the first image data from the first imaging unit 11 with the image of the second image data from the second imaging unit 12 and displays the overlapping images in the first overlapping region OA1. The bird's-eye view image creating unit 23 overlaps the image of the first image data from the first imaging unit 11 with the image of the third image data from the third imaging unit 13 and displays the overlapping images in the second overlapping region OA2. The bird's-eye view image creating unit 23 overlaps the image of the second image data from the second imaging unit 12 with the image of the fourth image data from the fourth imaging unit 14 and displays the overlapping images in the third overlapping region OA3. The bird's-eye view image creating unit 23 overlaps the image of the third image data from the third imaging unit 13 with the image of the fifth image data from the fifth imaging unit 15 and displays the overlapping images in the fourth overlapping region OA4. The bird's-eye view image creating unit 23 overlaps the image of the fourth image data from the fourth imaging unit 14 with the image of the sixth image data from the sixth imaging unit 16 and displays the overlapping images in the fifth overlapping region OA5. The bird's-eye view image creating unit 23 overlaps the image of the fifth image data from the fifth imaging unit 15 with the image of the sixth image data from the sixth imaging unit 16 and displays the overlapping images in the sixth overlapping region OA6. Values derived by multiplying the synthesis ratio by image data values are summed up when overlapping and synthesizing two image data sets of the overlapping regions OA1 to OA6 in this way. The synthesis ratio is a value associated with the image data sets and is stored in the storage unit 22. For example, the synthesis ratio of the respective image data is defined such that the synthesis ratio of the first image data is 0.5, the synthesis ratio of the second image data is 0.5, and so on. The plurality of image data sets in the overlapping regions OA1 to OA6 is averaged and displayed by using the synthesis ratios in this way. As a result, a natural bird's-eye view image can be created while suppressing dramatic changes in color or contrast. The bird's-eye view image creating unit 23 creates bird's-eye view image data that represents the bird's-eye view image synthesized as described above, and transmits the bird's-eye view image data to the display unit 18.

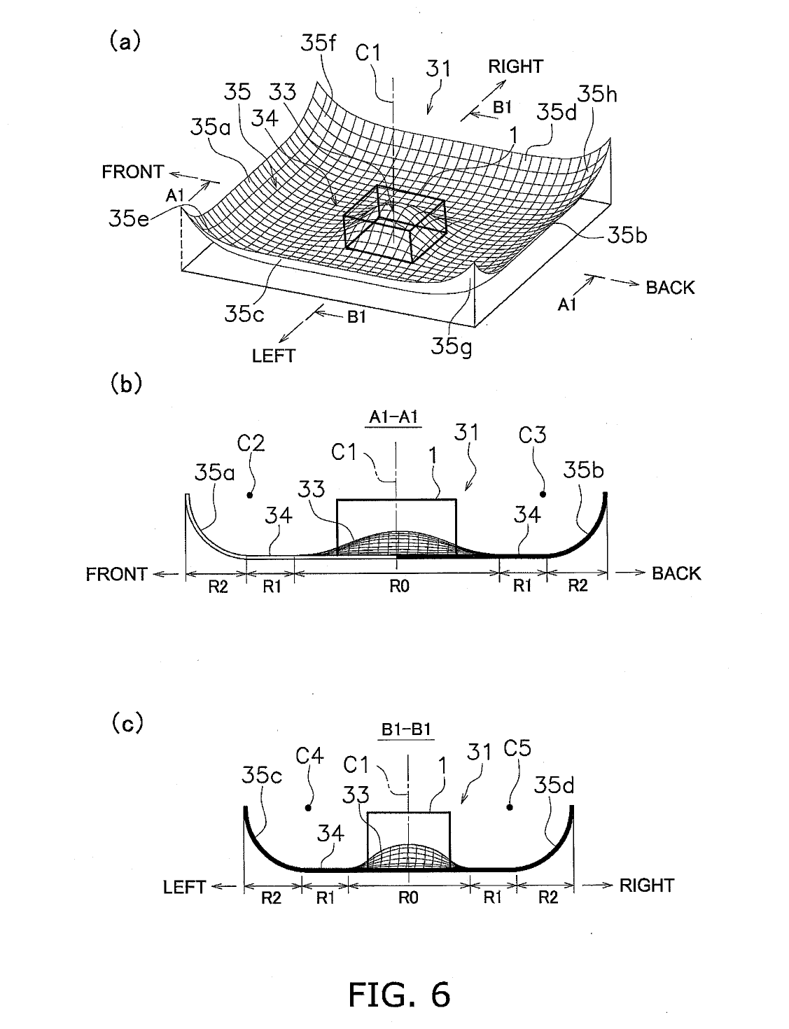

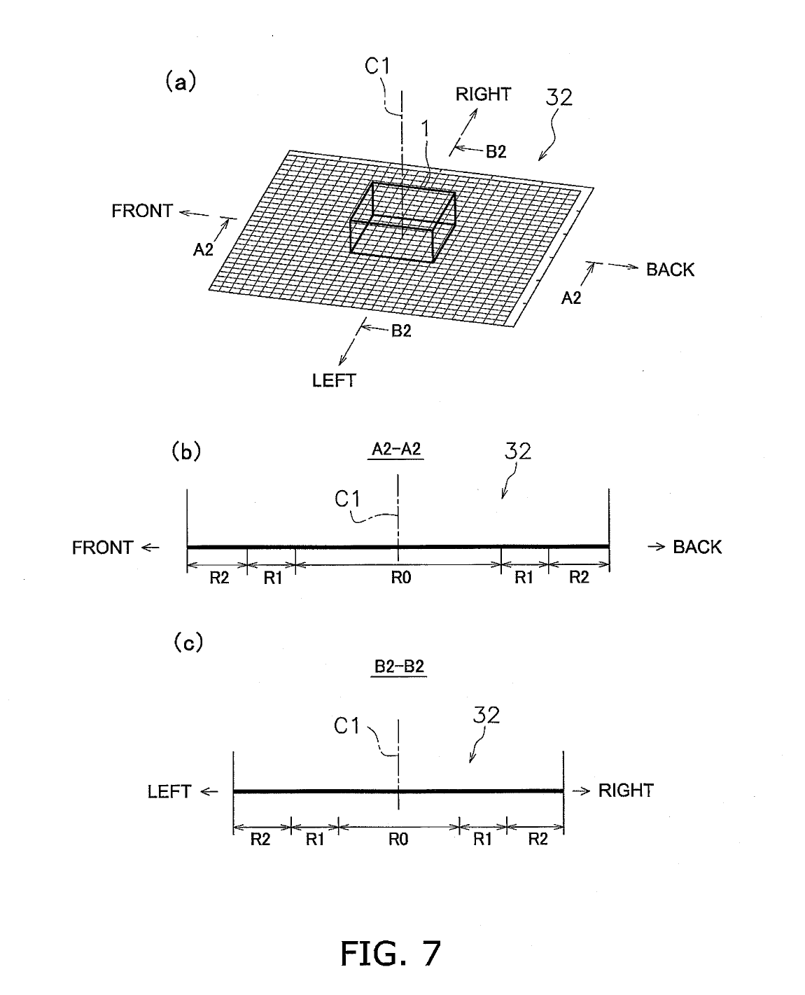

The bird's-eye view image creating unit 23 selectively uses a plurality of virtual projection planes to create the bird's-eye view image. Specifically, the bird's-eye view image creating unit 23 uses a first virtual projection plane 31 illustrated in FIG. 6 and a second virtual projection plane 32 illustrated in FIG. 7 to create the bird's-eye view image. FIG. 6(a) is a perspective view of the first virtual projection plane 31. FIG. 6(b) is a cross-section along lines A1-A1 of the virtual projection plane 31 in FIG. 6(a). FIG. 6(c) is a cross-section along lines B1-B1 of the virtual projection plane 31 in FIG. 6(a). FIG. 7(a) is a perspective view of the second virtual projection plane 32. FIG. 7(b) is a cross-section along lines A2-A2 of the virtual projection plane 32 in FIG. 7(a). FIG. 7(c) is a cross-section along lines B2-B2 of the virtual projection plane 32 in FIG. 7(a). As described above, the storage unit 22 stores the first conversion information and the second conversion information. The first conversion information is data that represents the first virtual projection plane 31. The second conversion information is data that represents the second virtual projection plane 32. The bird's-eye view image creating unit 23 uses the first conversion information when performing coordinate conversion of the image data to create the bird's-eye view image of the images imaged by the imaging units 11 to 16 projected on the first virtual projection plane 31. The bird's-eye view image creating unit 23 uses the second conversion information when performing coordinate conversion of the image data to create the bird's-eye view image of the images imaged by the imaging units 11 to 16 projected on the second virtual projection plane 32.

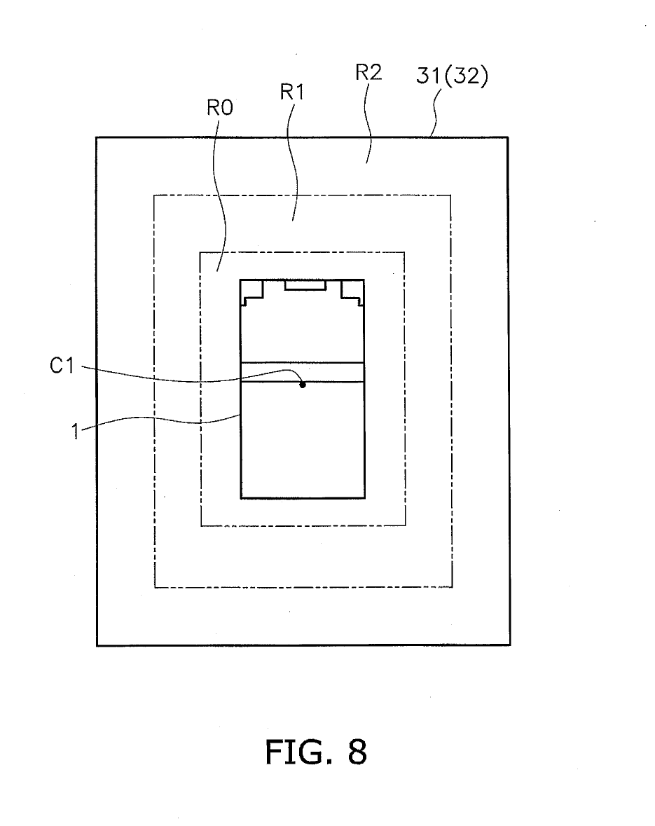

As illustrated in FIG. 6, the first virtual projection plane 31 includes a shape that increases in height from the ground surface in correspondence with proximity to the work vehicle 1 (i.e., the shape that increases in height from the ground surface as the distance from the work vehicle decreases). A center portion of the first virtual projection plane 31 is a shape that increases in height from the ground surface in correspondence with proximity to the work vehicle 1. An outer edge portion of the first virtual projection plane 31 is a shape that increases in height from the ground surface in correspondence with remoteness from the work vehicle 1 (i.e., the shape that increases in height from the ground surface as the distance from the work vehicle increases). As illustrated in FIG. 8, a range in the virtual projection planes 31 and 32 from the center C1 (referred to below as “vehicle center C1”) of the work vehicle 1 in the front and back direction and in the vehicle width direction, to locations that are a predetermined distance away from the work vehicle 1 to the front, right, left, and back directions is defined as a vicinal range R0. A range adjacent to the vicinal range R0 and located further away from the work vehicle 1 than the vicinal range R0 is defined as a first range R1. A range adjacent to the first range R1 and located further away from the work vehicle 1 than the first range R1 is defined as a second range R2. The second range R2 includes the outer edge portions of the virtual projection planes 31 and 32.

As illustrated in FIG. 6, the first virtual projection plane 31 includes a first varying portion 33, a flat portion 34, and a second varying portion 35. The first varying portion 33 is located in the vicinal range R0 illustrated in FIG. 8. The height from the ground surface of the first varying portion 33 increases in correspondence with proximity to the vehicle center C1. That is, the height from the ground surface of the first varying portion 33 increases in correspondence with proximity to the work vehicle 1. Therefore, the height from the ground surface of the vicinal range R0 of the first virtual projection plane 31 increases in correspondence with proximity to the work vehicle 1. The first varying portion 33 is a shape that inclines upward toward the vehicle center C1. An apex of the first varying portion 33 is located at a location corresponding to the inside of the work vehicle 1. The first varying portion 33 is located further below the imaging unit mounted in the lowest location among the plurality of imaging units 11 to 16. The flat portion 34 is located in the first range R1 of the first virtual projection plane 31. The flat portion 34 is continuously joined to the first varying portion 33 in a location further away from the work vehicle 1 than the first varying portion 33. A connecting portion of the first varying portion 33 and the flat portion 34 is located on the ground surface. The height from the ground surface of the flat portion is uniform. Therefore, the height from the ground surface of the first range R1 of the first virtual projection plane 31 is uniformly flat. Specifically, the flat portion 34 is a flat surface having the same height as the ground surface. Therefore, the first range R1 of the first virtual projection plane 31 has a flat shape that is the same height as the ground surface. The second varying portion 35 is located in the second range R2 of the first virtual projection plane 31. The second varying portion 35 is continuously joined to the flat portion 34 in a location further away from the work vehicle 1 than the flat portion 34. The height from the ground surface of the second varying portion 35 increases in correspondence with remoteness from the work vehicle 1. Therefore, the second range R2 of the first virtual projection plane 31 is a shape that increases in height from the ground surface in correspondence with remoteness from the work vehicle 1. The second varying portion 35 is a shape that inclines upward in a direction away from the work vehicle 1. A connecting portion of the second varying portion 35 and the flat portion 34 is located on the ground surface.

The second range R2, namely the second varying portion 35 of the first virtual projection plane 31, includes a plurality of curved surfaces 35a to 35d, and a plurality of spherical surfaces 35e to 35h. The curved surfaces 35a to 35d are curved around a virtual axis parallel to rectangular sides corresponding to the contour of the work vehicle 1. The spherical surfaces 35e to 35h are disposed between respective pairs of adjacent curved surfaces 35a to 35d. The spherical surfaces 35e to 35h are continuously joined to the pairs of adjacent curved surfaces 35a to 35d. Specifically, the second varying portion 35 includes first to fourth curved surfaces 35a to 35d and first to fourth spherical surfaces 35e to 35h. The first curved surface 35a is located in front of the work vehicle 1. The first curved surface 35a curves around a virtual axis C2 as illustrated in FIG. 6(a). The virtual axis C2 is an axis line parallel to the rectangular front surface side corresponding to the contour of the work vehicle 1. The second curved surface 35b is located behind the work vehicle 1. The second curved surface 35b curves around a virtual axis C3 as illustrated in FIG. 6(a). The virtual axis C3 is an axis line parallel to the rectangular back surface side corresponding to the contour of the work vehicle 1. The third curved surface 35c is located on the left of the work vehicle 1. The third curved surface 35c curves around a virtual axis C4 as illustrated in FIG. 6(b). The virtual axis C4 is an axis line parallel to the rectangular left side surface side corresponding to the contour of the work vehicle 1. The fourth curved surface 35d is located on the right of the work vehicle 1. The fourth curved surface 35d curves around a virtual axis C5 as illustrated in FIG. 6(b). The virtual axis C5 is an axis line parallel to the rectangular right side surface side corresponding to the contour of the work vehicle 1.

The first spherical surface 35e is disposed between the first curved surface 35a and the third curved surface 35c. The first spherical surface 35e is continuously joined to the first curved surface 35a and the third curved surface 35c. The second spherical surface 35f is disposed between the first curved surface 35a and the fourth curved surface 35d. The second spherical surface 35f is continuously joined to the first curved surface 35a and the fourth curved surface 35d. The third spherical surface 35g is disposed between the second curved surface 35b and the third curved surface 35c. The third spherical surface 35g is continuously joined to the second curved surface 35b and the third curved surface 35c. The fourth spherical surface 35h is disposed between the second curved surface 35b and the fourth curved surface 35d. The fourth spherical surface 35h is continuously joined to the second curved surface 35b and the fourth curved surface 35d.

The second virtual projection plane 32 has a flat shape as illustrated in FIG. 7. Specifically, the height from the ground surface of the entire second virtual projection plane 32 including the outer edge portions is uniformly flat. Therefore, the heights from the ground surface of the first range R1, the second range R2, and the vicinal range R0 in the second virtual projection plane 32 are uniformly flat. Specifically, the entire second virtual projection plane 32 has a flat shape located at the same height as the ground surface.

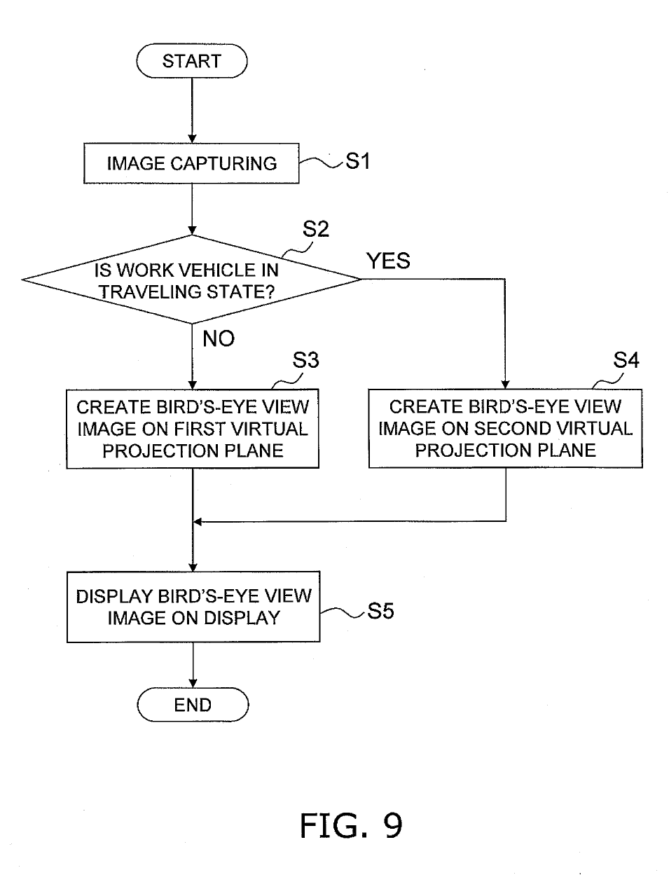

FIG. 9 is a flow chart of a process executed by the controller 19 of the surrounding area monitoring device 1. An explanation of processing for the surrounding area monitoring device 10 to display the bird's-eye view image will be described below with reference to FIG. 9.

First in step S1, the capturing of images is executed. Image data of images imaged by the cameras 11a to 16a of the respective imaging units 11 to 16 are stored in the frame memories 11b to 16b of the imaging units 11 to 16.

In step S2, a determination is made as to whether the work vehicle 1 is in a traveling state. The traveling state determining unit 21 determines whether the work vehicle 1 is in the traveling state on the basis of the vehicle speed. As described above, the traveling state determining unit 21 determines that the work vehicle 1 is in the traveling state when the vehicle speed is equal to or greater than a predetermined threshold. Moreover, the traveling state determining unit 21 determines that the work vehicle 1 is in a stopped state when the vehicle speed is less than the predetermined threshold. The routine advances to step S3 when the work vehicle 1 is not in the traveling state. That is, the routine advances to step S3 when the work vehicle 1 is in the stopped state.

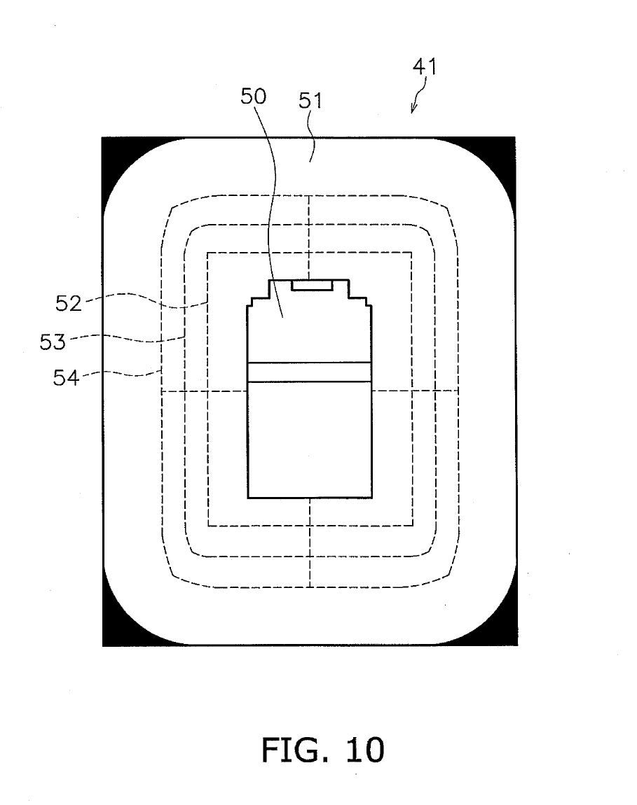

In step S3, the bird's-eye view image is created on the first virtual projection plane 31. The bird's-eye view image creating unit 23 uses the first virtual projection plane 31 illustrated in FIG. 6 and creates the bird's-eye view image. Specifically, the bird's-eye view image creating unit 23 creates the bird's-eye view image by projecting and synthesizing the image data from the imaging units 11 to 16 on the first virtual projection plane 31. FIG. 10 is an example of the created bird's-eye view image (referred to below as a “first bird's-eye view image 41”) using the first virtual projection plane 31. An outer frame of the first bird's-eye view image 41 has a rectangular shape. The first bird's-eye view image 41 includes a model figure 50 that shows the work vehicle 1 as seen from a top view, and an image 51 of the surrounding area of the work vehicle 1 as seen from a top view. The first bird's-eye view image 41 includes a plurality of reference lines 52 to 54 that show distances from the work vehicle 1. The reference lines 52 to 54 include a first reference line 52, a second reference line 53, and a third reference line 54. For example, the first reference line 52 represents a location that is 3 m away from the work vehicle 1. The second reference line 53 represents a location that is 5 m away from the work vehicle 1. The third reference line 54 represents a location that is 7 m away from the work vehicle 1. As described above, the second range R2 that includes the outer edge portions of the first virtual projection plane 31 is constituted by the curved surfaces 35a to 35d and the spherical surfaces 35e to 35h. As a result, the image 51 is displayed in a curved manner in the portions near the outer frame of the first bird's-eye view image 41.

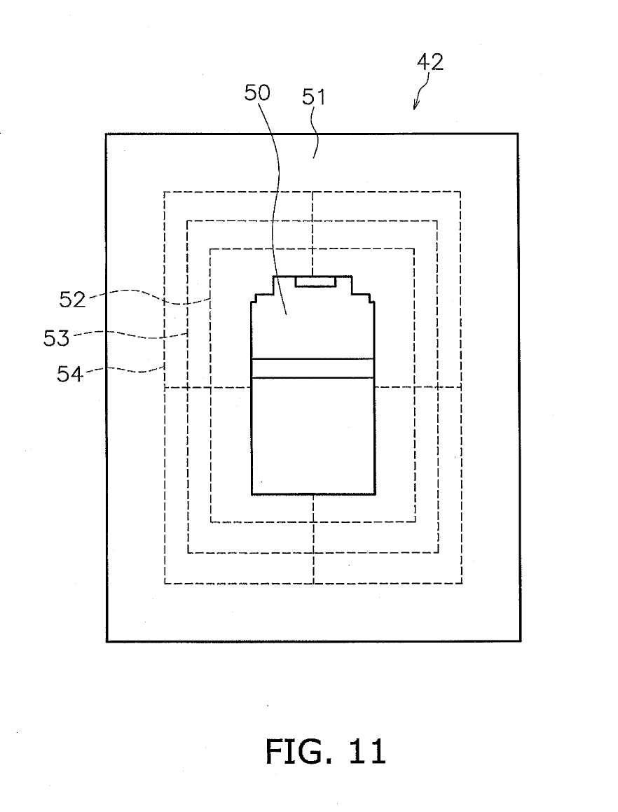

When the work vehicle 1 is determined to be in the traveling state in step S2, the routine advances to step S4. That is, the routine advances to step S4 when the vehicle speed is equal to or greater than the predetermined threshold. In step S4, the bird's-eye view image is created on the second virtual projection plane 32. FIG. 11 is an example of the created bird's-eye view image (referred to below as a “second bird's-eye view image 42”) using the second virtual projection plane 32. The second bird's-eye view image 42 includes the model figure 50 that shows the work vehicle 1 as seen from a top view, and the image 51 of the surrounding area of the work vehicle 1 as seen from a top view. The second bird's-eye view image 42 includes a plurality of reference lines 52 to 54 similar to the first bird's-eye view image 41. As described above, the second virtual projection plane 32 has an overall flat shape. As a result, displaying the image 51 in a curved manner as in the first bird's-eye view image 41 is prevented even in the portions near the outer frame in the second bird's-eye view image 42.

In step S5, the bird's-eye view image is displayed on the display unit 18. Here, the abovementioned first bird's-eye view image 41 or the second bird's-eye view image 42 is displayed on the display unit 18. Specifically, the first bird's-eye view image 41 is displayed on the display unit 18 when the work vehicle 1 is in the stopped state. The second bird's-eye view image 42 is displayed on the display unit 18 when the work vehicle 1 is in the traveling state.

Next, characteristics of the surrounding area monitoring device 10 in the work vehicle 1 according to the present embodiment will be described.

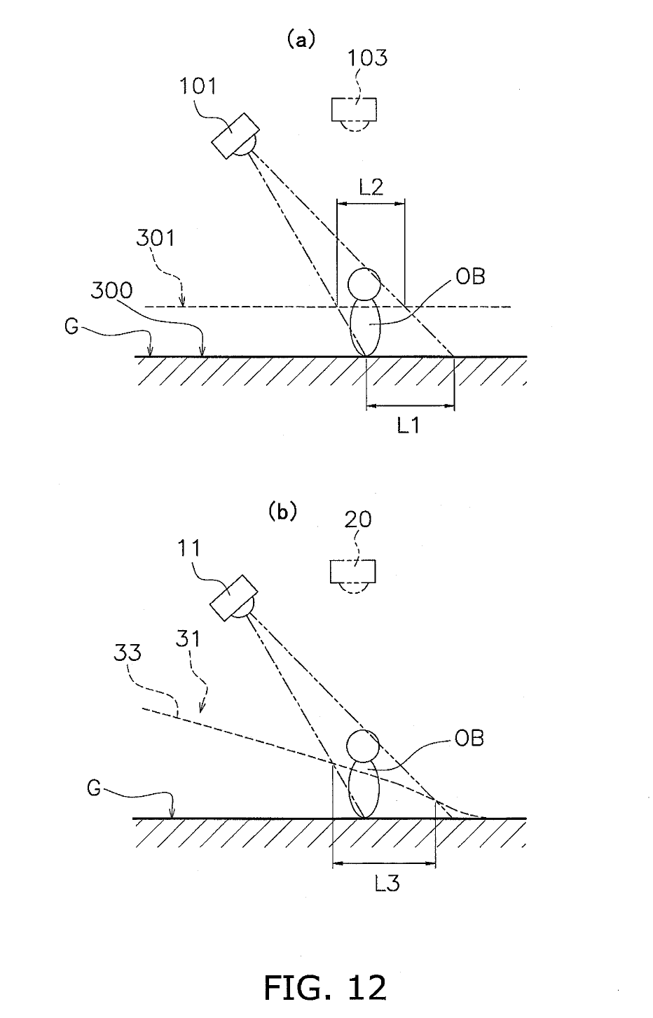

A size L3 (see FIG. 12(b)) of an object OB projected on the first varying portion 33 of the first virtual projection plane 31 in the present embodiment is larger than a size L1 (see FIG. 12(a)) of an object projected on a virtual projection plane 300 disposed on a ground surface G. As a result, even if the object OB is located near the work vehicle 1, the object OB is displayed in an enlarged manner in the first bird's-eye view image 41. Accordingly, the driver can easily recognize the object OB located near the work vehicle 1.

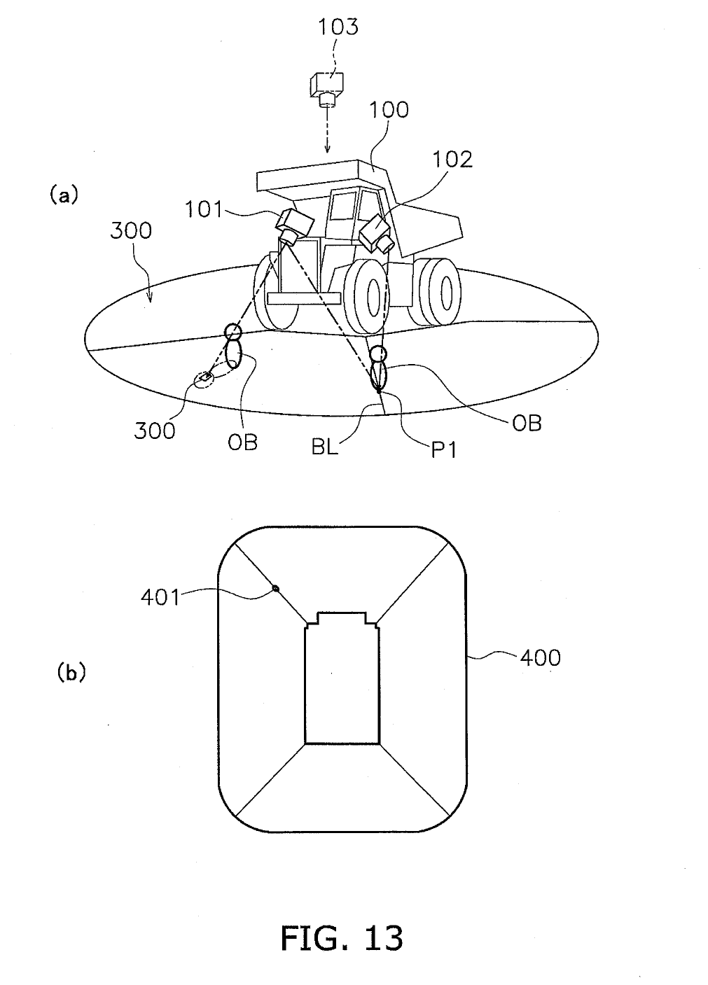

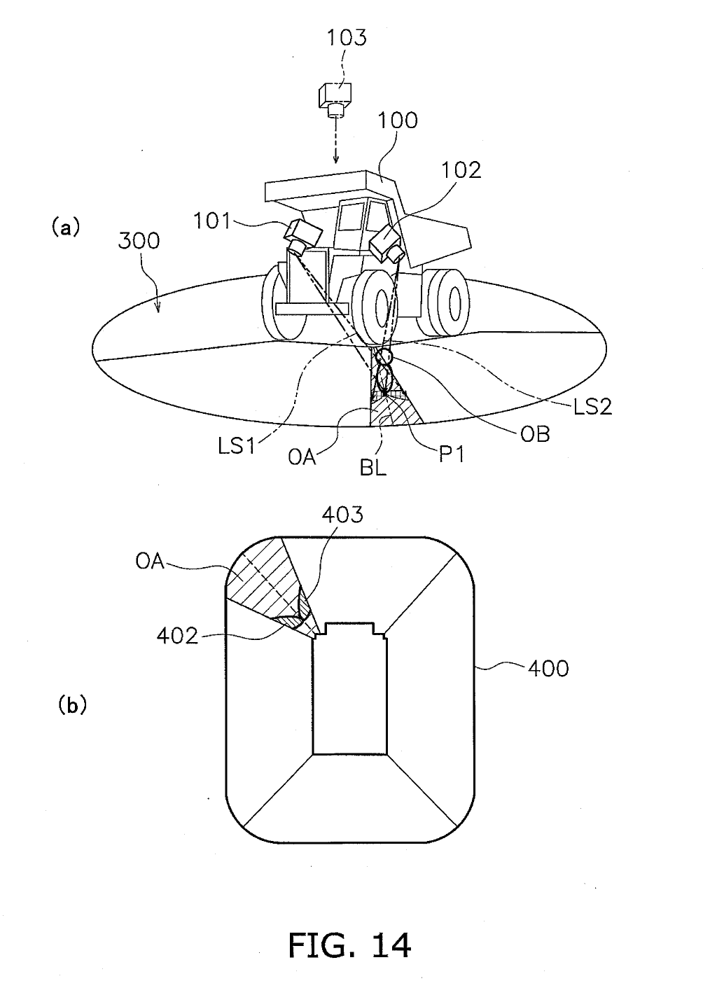

Generally, when the bird's-eye view image is synthesized from images imaged by a plurality of imaging units, there is a problem in that an object located in a boundary portion of imaging ranges of the imaging units disappears in the bird's-eye view image. For example, the following is an explanation of an example of creating a bird's-eye view image using the virtual projection plane 300 that is located at the same height as the ground surface as illustrated in FIG. 13(a). In this example, the virtual projection plane 300 is divided into regions imaged by the plurality of imaging units 101 and 102. The surrounding area monitoring device converts the images imaged by the imaging units 101 and 102 to a bird's-eye view image as seen from a virtual viewpoint 103 located above a work vehicle 100 by projecting the images imaged by the imaging units 101 and 102 on the virtual projection plane 300. In this case, the values of pixels 300 of the images projected on the virtual projection plane 300 are values of the pixels 300 seen from the imaging unit 101 that covers a region in which the pixels 300 are included. Therefore, when the object OB is located in the virtual projection plane 300 on a boundary BL of the regions of the two adjacent imaging units 101 and 102, a sight line of the imaging units 101 and 102 that pierces the top portion of the object OB does not exist. In this case, the imaging units 101 and 102 only image a placement portion P1 of the object OB on the ground surface. As a result, a figure 401 that shows the object OB in a bird's-eye view image 400 as illustrated in FIG. 13(b) is merely shown as a very small point, or the object disappears in the bird's-eye view image 400. The problem of the object disappearing in this way can be resolved by summing up the image data of the imaging ranges in the overlapping region of the imaging ranges. In this case, a sight line LS1 of the imaging unit 101 and a sight line LS2 of the imaging unit 102 that pierce the top portion of the object OB exist in the overlapping region OA as illustrated in FIG. 14(a). As a result, a figure 402 imaged by the imaging unit 101 and a figure 403 imaged by the imaging unit 102 are displayed together in the overlapping region OA in the bird's-eye view image 400 as illustrated in FIG. 14(b). Consequently, the disappearance of the object OB in the overlapping region OA is prevented.

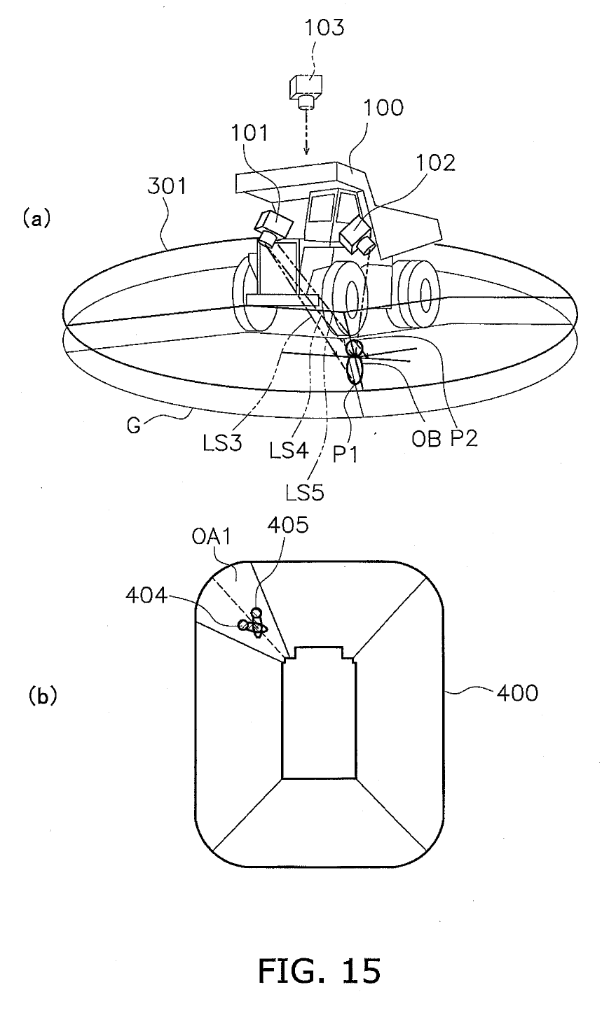

However, the overlapping region OA in the imaging range becomes narrower in correspondence with proximity to the work vehicle 100. As a result, when the object OB is located near the work vehicle 100, the range that can display the object OB becomes narrower. As a result, only a portion of the object OB is displayed in the bird's-eye view image 400. Accordingly, it is conceivable to project the object OB on a virtual projection plane 301 that is disposed in a location higher than the ground surface G as illustrated in FIG. 15(a). In this case, sight lines LS3 and LS4 exist that pass through the virtual projection plane 30 in a portion between the placement portion P1 of the object OB on the ground surface and the virtual projection plane 301. Moreover, a sight line LS5 exists that goes through an apex portion P2 of the object OB. As a result, a wide range of the object OB can be displayed in the bird's-eye view image 400 as illustrated in FIG. 15(b). A figure 404 imaged by the imaging unit 101 and a figure 405 imaged by the imaging unit 102 are displayed together in the bird's-eye view image 400. However, in this case, although the wide range of the object OB can be displayed in the bird's-eye view image 400, there is a problem in that the size of the object OB is reduced in the bird's-eye view image 400. For example, as illustrated in FIG. 12(a), the size L2 of the object OB projected on the virtual projection plane 301 disposed at a location higher than the ground surface G becomes smaller than the size L1 of the object OB projected on the virtual projection plane 300 disposed on the ground surface G. As described above, the object OB is displayed in a small manner in the bird's-eye view image near the work vehicle 1. As a result, when the virtual projection plane 301 disposed at a location higher than the ground surface G is used, the object OB located near the work vehicle 1 is displayed in an even smaller manner in the bird's-eye view image.

With respect to the above problems, the first varying portion 33 in the surrounding area monitoring device 10 of the work vehicle 1 according to the present embodiment is inclined to become higher from the ground surface in correspondence with proximity to the work vehicle 1. Accordingly, as illustrated in FIG. 12(b), the size L3 the object OB can be made larger in the bird's-eye view image than the size L2 of the object OB projected on the virtual projection plane 301 that is disposed in a location higher than the ground surface G. As a result, the problem of the disappearance of the object in the bird's-eye view image, the problem of the range in which the object is displayed becoming narrower, and the problem of the object being displayed in a small manner can be resolved at the same time.

The flat portion 34 of the first virtual projection plane 31 exists at a location further away from the work vehicle 1 than the first varying portion 33. Moreover, the object OB is displayed in an enlarged manner in the bird's-eye view image in a location further away from the work vehicle 1 than in the vicinity of the work vehicle 1. As a result, the problem of the object disappearing is resolved.

Although the object OB is displayed in an enlarged manner in correspondence with remoteness from the work vehicle in the flat portion 34, the second varying portion is provided in a location further away from the work vehicle 1 than the flat portion 34 on the first virtual projection plane 31. Since the second varying portion 35 increases in height from the ground surface in correspondence with remoteness from the work vehicle 1, the object OB is displayed in a smaller manner in correspondence with remoteness from the work vehicle 1. As a result, a feeling of distance between the object OB and the work vehicle 1 can be easily understood based on the first bird's-eye view image 41.

Further, the first varying portion 33 and the flat portion 34 are continuously joined. Moreover, the flat portion 34 and the second varying portion 35 are continuously joined. As a result, the object OB is smoothly displayed in the bird's-eye view image. Consequently, a bird's-eye view image can be created that causes little sense of discomfort for the operator.

The connecting portion of the first varying portion 33 and the flat portion 34 is located on the ground surface. The connecting portion of the second varying portion 35 and the flat portion 34 is located on the ground surface. That is, the flat portion 34 is a flat surface on the ground surface. As a result, a natural bird's-eye view image can be created that appears to be imaging the ground surface from the operator's point of view.

Although an embodiment of the present invention has been described so far, the present invention is not limited to the above embodiment and various modifications may be made within the scope of the invention.

Although a dump truck is raised as an example of the work vehicle 1 in the above embodiment, the present invention can be applied to other types of work vehicles such as, for example, a bulldozer.

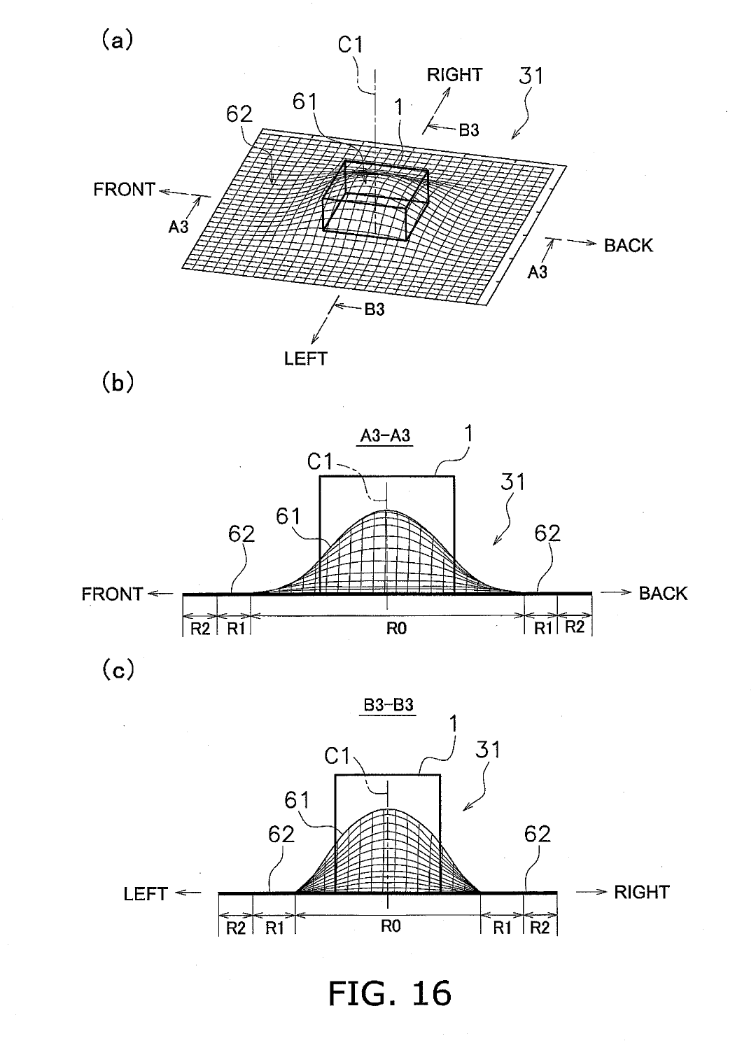

The second varying portion 35 in the first virtual projection plane 31 may be omitted. Specifically, the first virtual projection plane 31 may be constituted by a varying portion 61 and a flat portion 62 as represented in the first virtual projection plane 31 illustrated in FIG. 16. The varying portion 61 is similar to the first varying portion 33 of the above embodiment. Therefore, the varying portion 62 is a shape that increases in height from the ground surface in correspondence with proximity to the work vehicle 1. The varying portion 61 is located in the vicinal range R0. The flat portion 61 is located further away from the work vehicle 1 than the varying portion 61 and extends to the outer frame of the first virtual projection plane 31. Specifically, the flat portion 61 is located in a range that combines the first range R1 and the second range R2.

The number of the imaging units of the present invention is not limited to the six units as described in the above embodiment. Moreover, the dispositions of the imaging units of the present invention are not limited to the dispositions of the imaging units 11 to 16 in the above embodiment. Although the first varying portion 33 in the first virtual projection plane 31 in the above embodiment is an inclined surface in which the height from the ground surface varies continuously, the height of the first varying portion 33 from the ground surface may vary in a stepped manner. Similarly, the height from the ground surface of the second varying portion 35 may also vary in a stepped manner. However, from the point of view of forming a natural bird's-eye view image with little sense of discomfort, the first varying portion 33 preferably is an inclined surface in which the height from the ground surface varies continuously. Similarly, from the point of view of forming a natural bird's-eye view image with little sense of discomfort, the second varying portion 35 preferably is an inclined surface in which the height from the ground surface varies continuously. Moreover, the inclined surface of the first varying portion 33 may be linear or may be curved. Similarly, the inclined surface of the second varying portion 35 may be linear or may be curved. Moreover, the flat portion 34 of the first virtual projection plane 31 is not limited to the same height as the ground surface and may be located at a height that differs from the ground surface.

The illustrated embodiment is able to provide a surrounding area monitoring device for a work vehicle, the device capable of suppressing the disappearance of an object in a bird's-eye view image.

1. A surrounding area monitoring device for a work vehicle comprising:
a first imaging unit mounted on the work vehicle and configured and arranged to capture an image of a first region in a surrounding area of the work vehicle to obtain a first image data;
a bird's-eye view image creating unit configured to create a bird's-eye view image of the surrounding area of the work vehicle by projecting the first image data on a predetermined virtual projection plane; and
a display unit configured and arranged to display the bird's-eye view image,
the virtual projection plane including a shape that increases in height from a ground surface as a distance from the work vehicle decreases.

2. The work vehicle surrounding area monitoring device according to claim 1, wherein
the virtual projection plane includes a varying portion that increases in height from the ground surface as the distance from the work vehicle decreases, and a flat portion continuously joined to the varying portion in a location further away from the work vehicle than the varying portion and having a height from the ground surface that is uniform, and
the varying portion is located between the work vehicle and the flat portion.

3. The work vehicle surrounding area monitoring device according to claim 2, wherein
a connecting portion of the varying portion and the flat portion is located on the ground surface.

4. The work vehicle surrounding area monitoring device according to claim 1, wherein
the virtual projection plane includes a first varying portion that increases in height from the ground surface as the distance from the work vehicle decreases, a flat portion continuously joined to the first varying portion in a location further away from the work vehicle than the varying portion and having a height from the ground surface that is uniform, and a second varying portion continuously joined to the flat portion in a location further away from the work vehicle than the flat portion and having a height from the ground surface that increases as the distance from the work vehicle increases.

5. The work vehicle surrounding area monitoring device according to claim 4, wherein
a connecting portion of the second varying portion and the flat portion is located on the ground surface.

6. The work vehicle surrounding area monitoring device according to claim 1, further comprising
a second imaging unit mounted on the work vehicle and configured and arranged to capture an image of a second region of the surrounding area of the work vehicle that partially overlaps the first region to obtain a second image data, wherein
the bird's-eye view image creating unit is configured to display by overlapping, in the bird's-eye view image, an image of the first image data in an overlapping region in which the first region and the second region overlap, and an image of the second image data in the overlapping region.

7. A work vehicle comprising the surrounding area monitoring device according to claim 1.
